(19) United States
(12) Patent Application Publication
(10) Pub. No.: US 2016/0329666 A1
(43) Pub. Date: Nov. 10, 2016

(54) Portable USB-Style Hand Controller

(71) Applicant: LIMOSS (SHENZHEN) CO.,LTD, Shenzhen (CN)

(72) Inventor: Christian Gassner, Shenzhen (CN)

(73) Assignee: LIMOSS (SHENZHEN) CO.,LTD, Shenzhen (CN)

(21) Appl. No.: 14/804,966

(22) Filed: Jul. 21, 2015

(30) Foreign Application Priority Data
May 5, 2015 (CN) 2015202828810

(51) Int. Cl. H01R 24/60; H01H 13/02; H01H 13/14

(52) U.S. Cl. CPC H01R 24/60; H01H 13/14; H01H 13/023; H01R 2107/00

(57) ABSTRACT

The present invention discloses a portable USB-style hand controller, wherein, it comprises a remoter body and a size adapting cover covering the remoter body; hooks are arranged on the back of the cover, and slots adapting to the hooks are arranged at the according positions in a top shell of the remoter body; press buttons are arranged in a front of the cover. The portable USB-style hand controller, adding a USB charging function, can not only fulfill the regular remoter control functions for intelligent livings, also its USB interface is able to charge almost all intelligent devices in the market, including almost all intelligent phones and tablets, thus when people are using intelligent devices in daily life, they will no longer worry about low batteries; also the cover is easy to remove and install, convenient to users.

### FIELD OF THE INVENTION

The present invention relates to the field of remote control devices technology area, and more particularly, to a portable USB-style (Universal Serial Bus) hand controller.

### CROSS-REFERENCES TO RELATED APPLICATIONS

This application claims the priority of Chinese patent application no. 2015202828810, filed on May 5, 2015, the entire contents of all of which are incorporated herein by reference.

### BACKGROUND

In the era of mobile internet, the ways of people's leisure and work are undergoing tremendous changes, people may use intelligent devices (such as intelligent phones, tablets, intelligent watches and more) on various occasions for entertainment or work, however, the problem of battery runtime of these devices may bring troubles to users, which means these devices may need to be charged any time. A traditional product has a single remote function or charging function only, which has been unable to adapt to the people's life requirements in the internet era.

Therefore, the prior art needs to be improved and developed.

### BRIEF SUMMARY OF THE DISCLOSURE

The technical problems to be solved in the present invention is, aiming at the defects of the prior art, providing a portable wired USB-style hand controller, in order to solve the problem in the prior art, that the existing remoter products have no charging functions. The technical solution of the present invention to solve the technical problems is as follows:

A portable USB-style hand controller, wherein, it comprises a remoter body, and a cover; the cover snap-on covering the remoter body, while adapting to sizes of the remoter body; a hook is arranged on a back of the cover, and a slot adapting to the hook is arranged at an according position in a top shell of the remoter body; a press button is arranged in a front of the cover.

The portable USB-style hand controller, wherein, the hook contains a vertical section and a transverse section; the vertical section perpendicular to the back of the cover, and the transverse section perpendicular to the vertical section; the slot contains a first hole and a second hole; the first hole adapting to a terminal of the transverse section, the second hole connecting to the first hole, while adapting to the terminal of the vertical section.

The portable USB-style hand controller, wherein, a shape of a cross section of the remoter body is round, elliptical or polygonal.

The portable USB-style hand controller, wherein, a backlight structure is arranged on the press button.

The portable USB-style hand controller, wherein, the cross section of the press button is round, crescent or polygonal.

The portable USB-style hand controller, wherein, a number of the press button is at least two.

The portable USB-style hand controller, wherein, a USB interface is configured in the remoter body, while the USB interface is applied to connect to a charging circuit.

The portable USB-style hand controller, wherein, a USB interface slot is configured in the cover, adapting to the USB interface.

Benefits: the portable USB-style hand controller, adding a USB charging function, can not only satisfy the regular remoter control functions for intelligent livings, but also its USB interface is able to supply power to charge almost all intelligent devices in the market, including almost all intelligent phones and tablets, thus when people are using intelligent devices in daily livings, they will no longer worry about low batteries; also the cover is easy to remove and install, convenient to users.

### BRIEF DESCRIPTION OF THE DRAWINGS

FIG. 1 illustrates an explored view of a portable USB hand controller described in the present invention.

FIG. 2 illustrates a schematic diagram on a back cover of the portable USB-style hand controller described in the present invention.

FIG. 3 illustrates a schematic diagram of the cover of the portable USB hand controller before snap-on covering a remoter body in the first angle of view described in the present invention.

FIG. 4 illustrates a schematic diagram of the cover of the portable USB hand controller before snap-on covering the remoter body in the second angle of view described in the present invention.

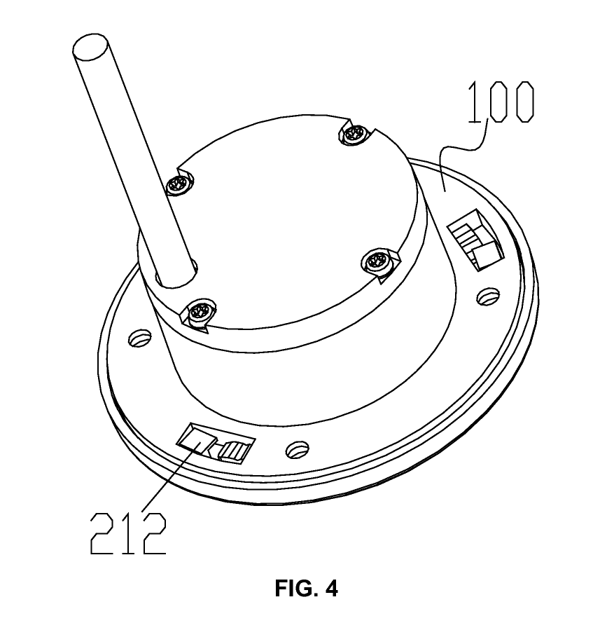

FIG. 5 illustrates a schematic diagram of the cover of the portable USB hand controller after snap-on covering the remoter body in the first angle of view described in the present invention.

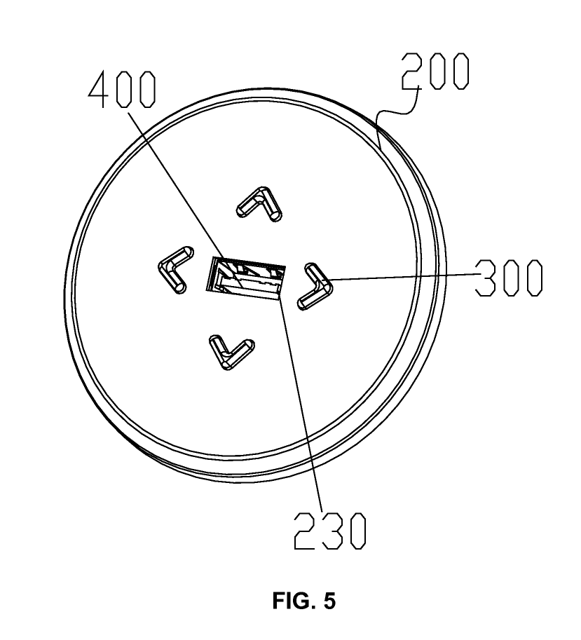

FIG. 6 illustrates a schematic diagram of the cover of the portable USB hand controller after snap-on covering the remoter body in the second angle of view described in the present invention.

FIG. 7 illustrates a cutaway perspective view of local section of the portable USB hand controller described in the present invention.

FIG. 8 illustrates an amplified schematic diagram of area A in FIG. 7.

### DETAILED DESCRIPTION

In order to make the purpose, technical solution and the advantages of the present invention clearer and more explicit, further detailed descriptions of the present invention are stated here, referencing to the attached drawings and some embodiments of the present invention. It should be understood that the detailed embodiments of the invention described here are used to explain the present invention only, instead of limiting the present invention.

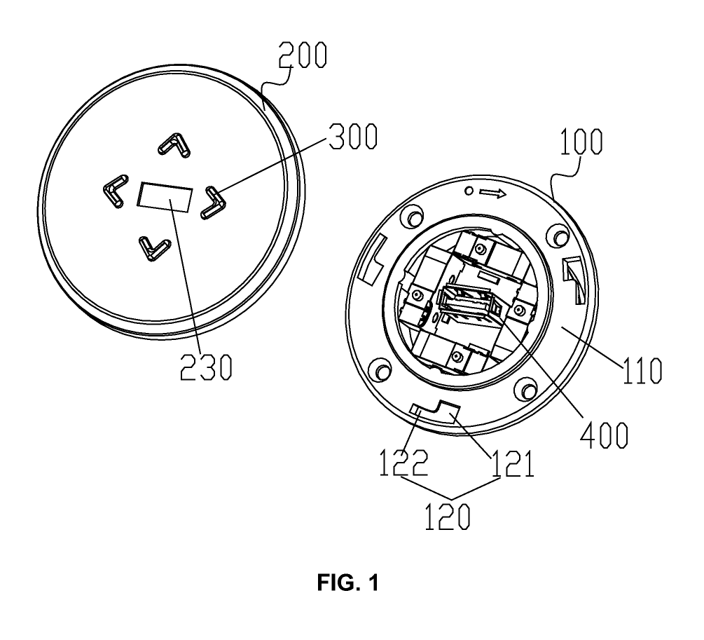

Referring to FIG. 1, a portable USB hand controller provided in the present invention, includes a remoter body 100, and a cover 200; the cover adapting to the sizes of the remoter body 100 and snap-on covering the remoter body 100. The connection between the remoter body 100 and the cover 200 is snap-on connection, i.e., it is possible to assemble the cover 200 onto the remoter body 100 through turning the cover 200, also, it is convenient to dissemble the cover 200 fast, it shows that, adopting snap-on connection method can not only lower the cost, but also make it convenient to assemble and dissemble. However, traditionally, most snap-on connections are adopting a plurality of pressed snaps for connections, which is easy for assembling, however, during dissembling processes, it is easy to hurt the hand controller, such as scratching the hand controller surfaces, damaging some parts inside the hand controller due to vibrations caused by excessive forces, or causing individual snap damages.

In specific embodiments of the present invention, a hook 210 is set on a back of the cover 200, accordingly, a slot 120 is arranged in the remoter body 100, configured to snap-on connect the hook 210, wherein, the remoter body 100 adapts to the cover 200, that is, the slot 120 adapting to the hook 210 is configured in the according position on the top shell 110 of the remoter body 100. The slot 120 arranged on the top shell 110 of the periphery of the remoter body 100 may accommodate the hook 210, and achieve fixation to the hook 210 after snap-on connecting the slot 120 to the hooks 210, that is, fixing the shell and making it not easy to get loosen in other direction. At least one hook 210 are arranged on the back of the cover 200, and the same number of the slot 120 as that of the hook 210 are arranged in the according positions in the remoter body 100. In a specific embodiment, the number of hook 210 is set to be three, then the number of the slot 120 is also set to be three, accordingly, and, the hook 210 is distributed unevenly, as well as processed with foolproof settings, in order to avoid user operations in error.

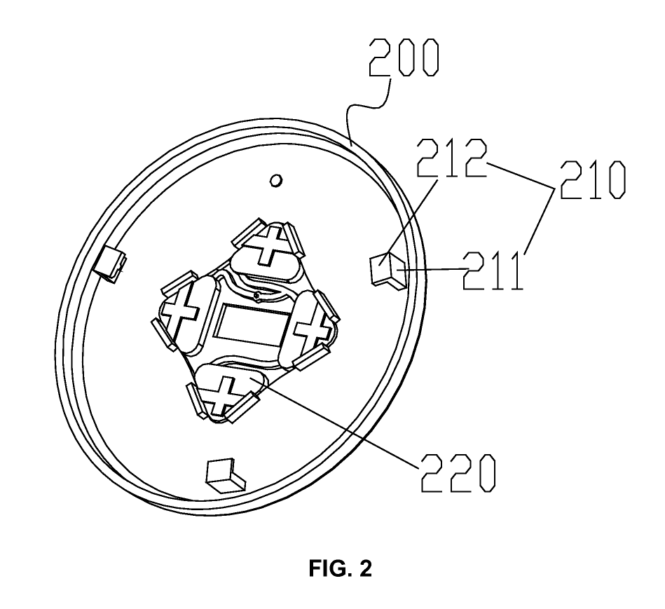

Furthermore, referring to FIG. 1 and FIG. 2 together, every hook 210 arranged on the back of the cover 200 includes a vertical section 211 and a transverse section 212; the vertical section 211 perpendicular to the back of the cover 200, and the transverse section 212 perpendicular to the vertical section 211. The vertical section 211 is arranged to locate the turning angles of the cover 200, while the transverse section 212 is arranged to fix the cover 200. Accordingly, each of the slot 120 includes a first hole 121 and a second hole 122; the first hole 121 adapting to a terminal of the transverse section 212, and the second hole 122 connecting to the first hole 121 while adapting to the terminal of the vertical section 211.

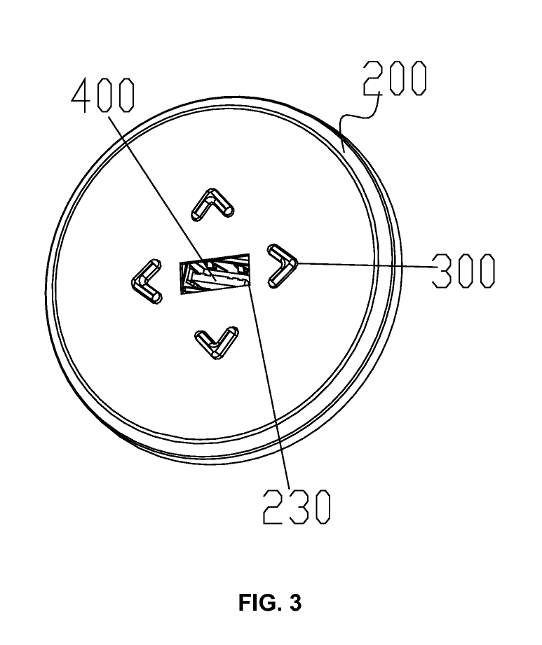

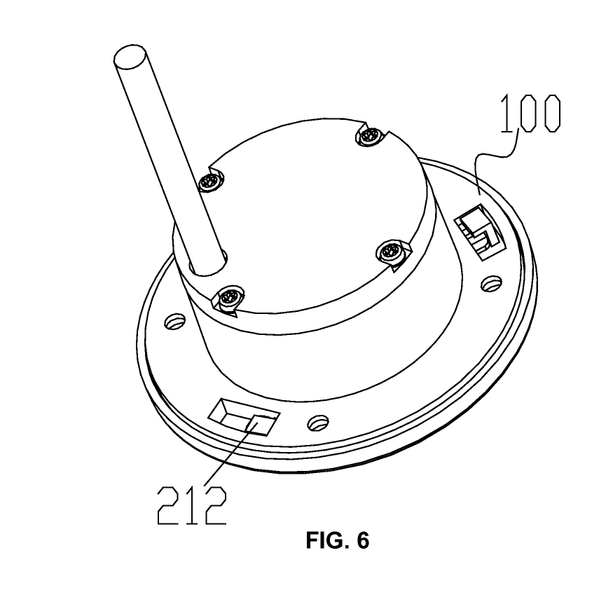

Referring to FIG. 3 up to FIG. 6 together, when assembling the cover 200 to the remoter body 100, it only needs to insert the hook 210 on the cover 200 into the corresponding first hole 121 in the slot 120, and then rotate the cover 200 in the clockwise direction, making the hook 210 insert into the second hole 122 in the slot 120, now the transverse section 212 of the hook 210 is adapting to the second hole 122 in the slot 120, and that finishes the snap-on connection between the cover 200 and remoter body 100. In the present invention, it is adopted that three hooks 210 and three slots 120 are arranged evenly on the cover 200 and the top shell 110 of the remoter body 100, accordingly. Of course, more hooks 210 and slots 120 connecting the cover 200 to the shell 110 may also be adopted.

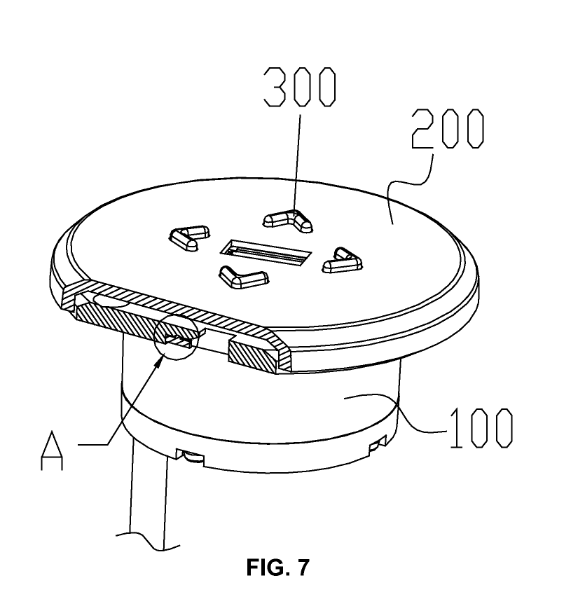

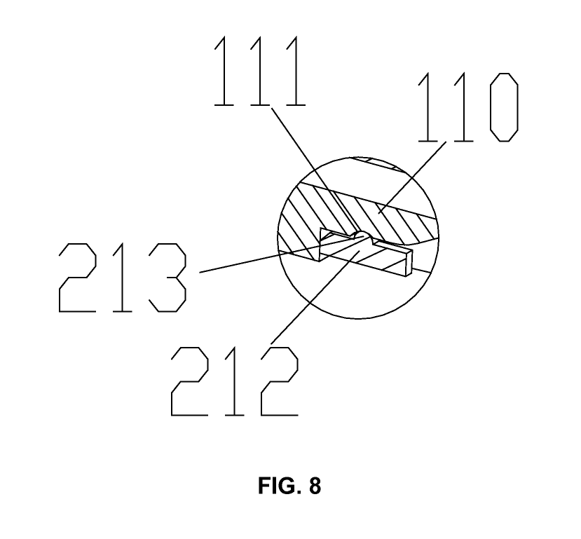

Furthermore, as shown in FIG. 7 and FIG. 8, a projection 213 is arranged on the transverse section 212 of the hook 210, the projection 213 is semi-circular shaped; a groove 111 is arranged on the top shell 110, according to the projection 213, the groove 111 adapts to the projection 213 after the cover 200 snap-on covering the remoter body 100, that is, the projection 213 is fixed in the groove 111, and that snap-on connects the cover 200 to the remoter body 100, while also fixing the cover 200, making the cover 200 not easy to get loosen in the other direction.

In an embodiment of the present invention, the cross section of the top shell 110 of the remoter body 100 is in round, elliptical or polygonal shapes. That is, the shell 110 may have a plurality of shapes, including round shapes, elliptical shapes or polygonal shapes. Different shapes adopted by the top shell 110 may provide different choices to customers, more options to customers, and provide a plurality of appearances for the products, that makes the products easy to sell.

Furthermore, as shown in FIG. 1, in the portable USB-style hand controller provided in the present invention, a press button 300 is arranged in a front face of the cover 200, and operating the press button 300 may control the according devices or appliances. The number of the press button 300 is at least two, and in one preferred embodiment of the present invention, the number of the press button 300 is four.

Furthermore, as shown in FIG. 2, a backlight structure 220 is arranged on the press button 300, and when the press button 300 is pressed, the backlight structure 220 will give out lights in different colors, that makes the press button 300 no longer monotonous. Backlight structure 220 may give out lights in blue, red, green, yellow or other colors. Of course, the colors give out from the backlight structure 220 in the present invention are not limited to those listed above, and they may be customized by users.

The press button 300 may also be set in different shapes. Specifically, the cross section shape of the press button 300 may be circular, crescent or polygonal shapes, and that increases the product's appearance beauty.

Furthermore, as shown in FIG. 1, a USB interface 400 is arranged in the remoter body 100, which connects to a charging circuit. That is, a charging function through USB interface is added to the hand controller, as provided in the present invention, which can not only satisfy the regular remoter control functions for intelligent livings, but also its USB interface is able to supply power to charge almost all intelligent devices in the market, including almost all intelligent phones and tablets.

Accordingly, as shown in FIG. 1, a USB interface slot 230 adapting to the USB interface 400 is arranged in the cover 200. When in use, a USB cable may connect the device for charge to the USB interface 400 and start charging. Thus when people are using intelligent devices in daily living, they will no longer worry about low batteries.

In summary, the present invention discloses a portable USB-style hand controller, wherein, it comprises a remoter body, and a cover snap-on covering the remoter body while adapting to sizes of the remoter body; hooks are arranged on the back of the cover, and slots adapting to the hooks are arranged at the according positions in a top shell of the remoter body; press buttons are arranged in a front of the cover. The portable USB-style hand controller provided in the present invention, adding a USB charging function, can not only satisfy the regular remoter control functions for intelligent livings, but also its USB interface is able to supply power to charge almost all intelligent devices in the market, including almost all intelligent phones and tablets, thus when people are using intelligent devices in daily life, they will no longer worry about low batteries; also the cover is easy to remove and install, convenient to users.

It should be understood that, the application of the present invention is not limited to the above examples listed. It will be possible for a person skilled in the art to make modification or replacements according to the above descriptions, which shall all fall within the scope of protection in the appended claims of the present invention.

What is claimed is:

1. A portable USB-style hand controller, wherein, it comprises a remoter body, and a cover; the cover snap-on covering the remoter body, while adapting to sizes of the remoter body; a hook is arranged on a back of the cover, and a slot adapting to the hook is arranged at an according position in a top shell of the remoter body; a press button is arranged in a front of the cover.

2. The portable USB-style hand controller according to claim 1, wherein, the hook contains a vertical section and a transverse section; the vertical section perpendicular to the back of the cover, and the transverse section perpendicular to the vertical section; the slot contains a first hole and a second hole; the first hole adapting to a terminal of the transverse section, the second hole connecting to the first hole, while adapting to the terminal of the vertical section.

3. The portable USB-style hand controller according to claim 1, wherein, a shape of a cross section of the remoter body is round, elliptical or polygonal.

4. The portable USB-style hand controller according to claim 1, wherein, a backlight structure is arranged on the press button.

5. The portable USB-style hand controller according to claim 1, wherein, the cross section of the press button is round, crescent or polygonal.

6. The portable USB-style hand controller according to claim 5, wherein, a number of the press button is at least two.

7. The portable USB-style hand controller according to claim 1, wherein, a USB interface is configured in the remoter body, while the USB interface is applied to connect to a charging circuit.

8. The portable USB-style hand controller according to claims 7, wherein, a USB interface slot is configured in the cover, adapting to the USB interface.
